(19) United States
(12) Patent Application Publication
(10) Pub. No.: US 2003/0102289 A1
(43) Pub. Date: Jun. 5, 2003

(54) Device for inscribing objects using laser beams

(76) Inventors: Robert Nissels, Fontainemelon (CH); Jean-Claude Vuilleumier, Cortaillod (CH)

Correspondence Address: DORSEY & WHITNEY LLP, INTELLECTUAL PROPERTY DEPARTMENT, 50 SOUTH SIXTH STREET, MINNEAPOLIS, MN, 55402-1498, US

(21) Appl. No.: 10/279,525

(22) Filed: Oct. 24, 2002

Related U.S. Application Data
(63) Continuation of application No. PCT/CH01/00254, filed on Apr. 23, 2001.

(30) Foreign Application Priority Data
Apr. 25, 2000 (CH) CH 2000 0809/00

(51) Int. Cl. B23K 26/36; B23K 26/06

(52) U.S. Cl. 219/121.68; 219/121.73; 219/121.74

(57) ABSTRACT

A device for inscribing an object, including a laser emitter for emitting at least one laser beam and an arrangement of diverting means for directing the at least one laser beam from the exit point of the laser emitter to a focal point on the object, wherein, in one embodiment, each laser beam is assigned to a diverting means, depending on the exit angle of the laser beam from the laser emitter so that at least two sides of the object my be inscribed and, in another embodiment, the diverting means is movable so that at least two sides of the object may be inscribed by movably arranging the diverting means.

### PRIORITY CLAIM

This application is a Continuation of International Patent Application No. PCT/CH01/00254, filed on Apr. 23, 2001, which claims priority to Swiss Application No. 809/00, filed on Apr. 25, 2000, both of which are incorporated herein by reference.

### BACKGROUND

Increasing regulatory requirements for identifying products or their packaging, in particular products which can endanger people's health such as medicinal products, pharmaceuticals and foodstuffs, mean that various information has to be provided on these products.

In addition to providing this information on the products or the packaging using stamps, laser technology means are increasingly applied. DE 41 25 007 and WO 99/21722 each disclose devices for providing information on labels, packaging and products. Inscribing is performed by burning into the surface of the objects and/or into a special coating arranged on the surface.

### SUMMARY

The invention is based on the object of providing a device and method for inscribing objects using laser beams, which enables an object or workpiece to be inscribed from a number of sides without having to change its position.

The object is addressed by a first embodiment by a device comprising a laser emitter for emitting a laser beam and at least one mapping means for mapping the laser beam from the laser emitter onto a focal point on the workpiece. The laser emitter is designed to emit a laser beam at at least two different exit angles, wherein, depending on the exit angle of a laser beam from the laser emitter, at least one laser beam is assigned to a diverting means, such that at least two different sides of the workpiece can be inscribed without changing the position of the workpiece.

The object is addressed by a second embodiment by a device consisting of a laser emitter emitting a laser beam and an arrangement of diverting means for directing the laser beams from the exit point of the laser emitter to a focal point on the object. A number of sides of the object may be inscribed by movably arranging the diverting means.

The advantages achieved by the invention are substantially to be seen in the fact that no additional production steps are required to inscribe the object on a number of sides.

In accordance with the present invention, the device for inscribing an object using a laser beam comprises a laser emitter for emitting a laser beam and at least one mapping means for mapping the laser beam from the laser emitter onto a focal point on or on top of the object, wherein the laser emitter is designed such that a laser beam can be emitted at at least two different exit angles and, depending on the exit angle of a laser beam from the laser emitter, the at least one laser beam is assigned to a diverting means, such that at least two different sides of the object can be inscribed without changing the position of the object.

In accordance with the invention, a number of beam paths can therefore be set in advance, for example, through adjusting and focusing, wherein the beam paths are each designed such that, when a laser beam passes through one, another side of the object to be inscribed is inscribed. Simply by selecting the angle at which the laser beam is exiting from the exit opening of the laser emitter, the beam path to be passed through and therefore the side of the object to be inscribed can be selected, without the necessity of additional, elaborate adjusting and focusing.

For changing the exit angle, the laser emitter preferably comprises a deflecting means subsequent to the laser, for which a galvano-mirror may be used.

If the object or workpiece is not inscribed by exposing a mask containing writing but by slightly varying the exit angle of the laser beam from the laser emitter, then the deflecting means can also advantageously be used to provide the slight variations in the exit angle of the laser beam from the laser emitter, necessary for laser writing.

It is advantageous if the deflecting means provided for this purpose is arranged near to the laser, where the light beam exiting from the laser still has a comparatively small beam diameter. In this way, comparatively small mirrors can be attached to the deflecting means, which can therefore exhibit a comparatively small mass and thus comparatively small inertia, such that laser inscribing is advantageously rapid and can be performed by an advantageously small device.

In one embodiment, the writing process is preferably performed by a light beam hitting the surface of the object to be inscribed substantially perpendicularly. In accordance with one embodiment of the invention, the laser beam exiting from the laser emitter in a substantially straight line is used to inscribe the front side of the object. To inscribe other sides of the object, in particular the left/right side or upper/lower side, the laser beams exiting at the other, predefined exit angle are directed to the respective side of the object to be inscribed using suitably positioned diverting means, such that the diverted laser beam hits the surface to be inscribed substantially perpendicularly. In order to adjust the device, the object then only has to be positioned with its front face in the beam path of the light beam exiting from the laser emitter in a straight line, and a suitable distance from the laser emitter selected.

In accordance with this embodiment, there is a difference in optical path length between the beam path of the straight laser beam, i.e., that hitting the front side of the object to be inscribed, and the at least one beam path comprising a diverting means, for example, a mirror. According to each beam path, such differences in optical path length cause different focusing and different mapping conditions. In the case of continuous laser writing, the different focusing conditions according to each beam path can result in a different thickness and brightness of the writing. The different mapping conditions can, according to each beam path, result in a different size of writing, if the deflecting means provided in the laser emitter causes laser writing in each of the beam paths in the same way.

To compensate for the differences in optical path length, a compensating means can be provided in the shortest beam path, in particular for the light beam hitting the front side of the object, and/or in at least one other beam path of the device, such that the optical path lengths of all the beam paths of the device are substantially the same. In this way, substantially uniform focusing and mapping conditions can be provided in all the beam paths of the device, in an advantageously simple way. Writing can therefore be applied to sides of the object to be inscribed with the same intensity and size.

It is advantageous if all the beam paths can be focused using a single lens or objective.

A lens, in particular a defocusing lens, arranged in the shortest beam path, for example, that hitting the front side of the object, an arrangement of mirrors arranged in a top view on the ends of a rectangle and at 45° to the sides of the rectangle or a pair consisting of one 90° prism and two mirrors, the base side of the prism facing the mirrors arranged at 45°, are, in one embodiment, suitable as compensating means.

In order to be able to use the device in accordance with the invention even more flexibly, changes in the optical path lengths of the other beam paths, i.e., the beam paths with the diverting means, can be compensated for by varying the distance between the mirrors and the reflector arrangement in the compensating means.

### BRIEF DESCRIPTION OF THE DRAWINGS

FIG. 1a depicts a preferred laser inscribing device in accordance with the invention;

FIG. 1b depicts a support device arranged for the preferred device;

FIG. 2 depicts a different embodiment of the laser inscribing device in accordance with the invention;

FIG. 3 depicts a further embodiment of the laser inscribing device in accordance with the invention.

### DETAILED DESCRIPTION

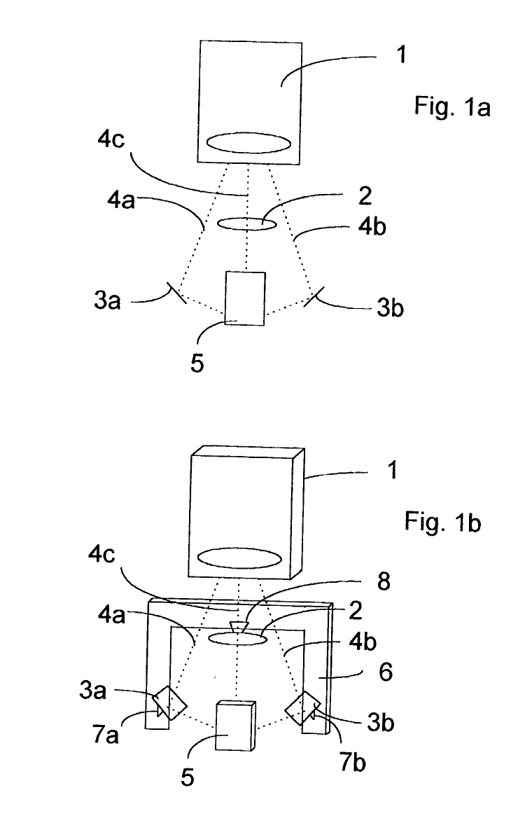

FIG. 1 shows one preferred embodiment of the present invention, consisting of a device generating laser beams 4a, 4b, 4c of equal intensity, referred to in the following as the laser emitter 1, a lens 2 and two mirrors 3a, 3b. A workpiece 5 is situated in the center between the lens 2 and the mirrors 3a, 3b. In order to be able to inscribe the same object 5 on a number of sides without changing its position, the laser beams 4a, 4b, 4c of equal intensity generated by the laser emitter 1 must be able to hit the surface of the object 5 or onto a special layer arranged on the surface of the object 5. The paths which the laser beams 4a, 4b, 4c have to travel to reach different sides of the object 5 are of different lengths; only one side of the object 5 can be perpendicular to the laser emitter 1, the other sides of the object 5 are situated near to or further away from the laser emitter 1, depending on the shape of the object. The laser beams 4a, 4b, 4c must be able to be diverted using the mirrors 3a, 3b and the lens 2, in order to be able to hit the appropriate side of the surface perpendicularly. In order to keep the intensity of the laser beam 4c—in particular, the focus diameter on the surface of the object—the same as that of the other laser beams 4a, 4b, the path of the laser beam 4c is artificially lengthened using a lens 2, a relatively weak defocusing lens, such that the path of the laser beam 4c is identical to the paths of the laser beams 4a, 4b via the mirrors 3a, 3b.

Depending on the model, the laser emitter 1 emits the laser beams 4a, 4b, 4c either sequentially or simultaneously. For simultaneously emitting a number of laser beams 4a, 4b, 4c at different exit angles, a suitable deflecting means can be provided at the exit opening of the laser emitter 1 and subsequent to the laser contained in said laser emitter 1. This can be a combination of suitable beam dividers which are dimensioned such that the intensities in the three beam paths 4a-c are substantially equal. The deflecting means can also be an acousto-optical modulator which diffracts the light exiting from the laser into the various orders of diffraction (−1 order of diffraction, 0 order of diffraction, +1 order of diffraction) on the basis of an acoustic standing wave formed in the modulator. Both the order of diffraction and the diffracted-out intensity can be selected to almost any value.

The side of the object 5 perpendicular to the laser emitter 1 is inscribed such that the laser beam 4c is exiting from the laser emitter and, through the lens 2, hits the surface of the object 5 or a special layer arranged on the surface of the object 5 and discolors a particular point by burning it. Small changes in the exit angle of the laser beam 4c from the laser emitter 1 result in the beam moving over the surface or special layer of the object 5 and burning it in such a way that characters are applied which can be read on the object 5.

In order to generate the small changes in the exit angle, necessary for inscribing, a deflecting means can be arranged in the laser emitter 1, subsequent to the laser, which slightly changes the exit angle, preferably computer-controlled. A galvano-mirror, or a combination of two galvano-mirrors with mutually orthogonal axis for adjusting them in two spatial directions, may be used for this purpose. Suitable combinations of X/Y or θ adjusting units or combinations of such units with one or more galvano-mirrors are also possible as deflecting means. These should be computer-navigated, for generating writing by beam deflection.

If another side of the same object 5 is to be inscribed, a larger change in the exit angle of the laser beam 4a, 4b from the laser emitter 1 changes the path such that the laser beam 4a, 4b hits a mirror 3a, 3b on another side of the object 5. This side of the object 5 is similarly inscribed using slight changes in the exit angle.

The large change in the exit angle can also be generated by a deflecting means arranged in the laser emitter 1, subsequent to the laser. The aforementioned deflecting means may be used for this purpose.

The laser beams 4a, 4b and 4c differ only in their different exit angles from the laser emitter 1. The optical path lengths of the different beam paths 4a, 4b and 4c do, however, differ. In the triatically symmetrical arrangement shown in the figures, the path lengths of the beam paths 4a and 4b corresponding to the sides of the triangle are substantially equal, while the length of the beam path 4c corresponding to the mid-perpendicular is shorter.

The different optical path lengths in the beam paths 4a-c result in different focusing and mapping conditions in the individual beam paths. If, as shown in FIG. 1, a lens or objective is provided at the exit opening of the laser emitter 1, which is designed such that the beam paths 4a and 4b which follow the sides of the triangle are focused in a straight line onto the lateral surfaces of the object 5, then the laser beam 4c exiting in a straight line from the laser emitter 1, without the presence of the lens 2, would not be focused on the front side of the object 5, which would result in blurred writing, a different thickness of the writing, a different size and the like. To compensate for the difference in optical path length, a lens or objective 2 is provided in the shorter beam path 4c, i.e. that exiting in a straight line from the laser emitter 1, which results in the laser beam in this beam path being slightly defocused. The focal point of the lens or objective 2 is selected such that the laser beam 4c exiting from the laser emitter 1 is focused onto the front side of the object 5 in the same way as in the beam paths 4a and 4b. This ensures the same intensity or type size.

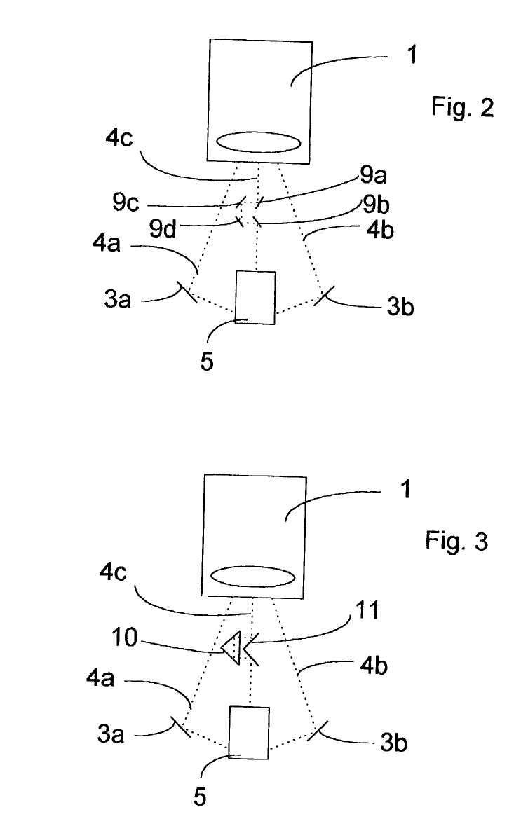

FIG. 2 shows a different embodiment of the device in accordance with the invention. Instead of diverting or defocusing via the lens 2, the path of the perpendicular laser beam 4c is lengthened using other mirrors 9a-9d. In particular, the optical path length in the middle beam path 4c is adjusted to the optical path length of the beam paths 4a, 4b by the arrangement of mirrors 9a-9d which act as a compensating means.

The arrangement of mirrors 9 shown in FIG. 2 corresponds to a retro-reflector arrangement, comprising mirrors 9a-b arranged at the corner points of a rectangle (in a top view) and at 45°, such that the beam travelling perpendicularly to the beam path 4c back and forth in the reflector arrangement is directed to the front side of the object 5 using the exit mirror 9b.

FIG. 3 shows a further embodiment of the device in accordance with the invention. Instead of diverting via the lens 2, a V-shaped combination of mirrors 11 and a 90° prism 10 feature. This embodiment also results merely in a lengthening of the path of the perpendicular laser beam 4c, and serves to compensate for differences in optical path length. The 90° prism 10 acts as a retro-reflector for the light beam entering from the upper mirror 11, which is reflected parallel but axially offset with respect to the lower exit mirror 11 and is mapped via the same onto the front side of the object 5.

In the arrangement in accordance with FIGS. 2 and 3, a change in the length of the beam paths 4a, 4b, arising for example when the beams 4a, 4b are to no longer hit the object perpendicularly but rather at a different angle or when the object is to be arranged further away from the laser emitter 1, can be compensated for by changing the distance between the entry and exit mirrors 9a, 9b; 11 and the reflector mirrors 9c, 9d or the prism 10 of the compensating means. In some embodiments, this distance is preferably changed computer-controlled. Since a retro-reflector is used in accordance with the invention, the position of the laser beam 4c on the front side of the object 5 is not changed, even when this distance is changed.

Due to the fact that the differences in optical path length between the different beam paths 4a-c are compensated for using the lens 2 or the compensating means 9, 10, 11, a single objective can be used for all the beam paths, which is cost-effective. This objective can, for example, be arranged at the exit opening of the laser emitter 1. A high-quality precision objective, which can, as appropriate, contain the writing to be inscribed as a mask, can therefore be used in the aforementioned embodiments.

If inscribing is not performed by exposing a mask containing the writing to be applied, but rather by deflecting the writing beam, then the slight changes in the exit angle of the laser beams necessary for this can be performed either using the deflecting means in the laser emitter 1 or directly, using the diverting means 3a, 3b of the respective beam paths. Suitable deflecting means are familiar to the person skilled in the art. In particular, a galvano-mirror or a combination of a number of galvano-mirrors or a combination of galvano-mirrors and mechanical positioning units or an aousto-optical modulator can be provided in the laser emitter, near its exit opening. The diverting mirrors 3a, 3b can also be galvano-mirrors.

In the case of asymmetrical objects, different lenses can additionally be combined with different mirror positions, in order to inscribe the different sides of the object 5.

More basic laser emitters 1 only allow small changes to a substantially perpendicular exit angle of a laser beam 4c. In such laser emitters 1, the laser beam 4c is diverted—in order to select a particular side of the object 5—via movably arranged diverting means 2, 3a, 3b, 9a-9d, 10, 11. In such laser emitters 1, small changes in the exit angle of the laser beam 4c also serve for inscribing the selected side of the object 5. Only navigating to the side of the object 5 is performed by moving the diverting means 2, 3a, 3b, 9a-9d, 10, 11.

In order to enable the mirrors 3a, 3b and the lens 2 to be arranged to be as stable as possible, in one embodiment, the mirrors 3a, 3b and lens 2 are preferably attached to an arch-shaped support device 6 (FIG. 1b) which lies outside the axes of the laser beams 4a, 4b, 4c, in such a way that they are attached to holding devices 7a, 7b, 8 protruding from the arch 6, and protrude into the axes of the laser beams 4a, 4b, 4c. The laser emitter 1 and arch 6 are preferably formed as one piece, in order to prevent changes in their positioning with respect to each other, through shaking. They can, however, also be built as independent devices, as shown in FIG. 1b.

In some embodiments, the object or workpiece 5 is preferably situated on a production line (not shown), such that the object 5 is automatically moved once it has been successfully inscribed, and the next object to be inscribed appears in its place.

Some more embodiments of the invention are outlined in the following:

A. A device for inscribing an object (5), consisting of:

a) a laser emitter (1) emitting laser beams (4a, 4b, 4c) of identical intensity;

b) an arrangement of diverting means (2, 3a, 3b, 9a-9d, 10, 11) for directing the laser beams (4a, 4b, 4c) from the exit point of the laser emitter (1) to a focal point on the object (5); wherein, depending on the exit angle of a laser beam (4a, 4b, 4c) from the laser emitter (1), the laser beam (4a, 4b, 4c) in each case is assigned to a diverting means (2, 3a, 3b, 9a-9d, 10, 11), wherein at least two sides of the object (5) may be inscribed in this way.

B. The device as set forth in embodiment A, wherein the diverting means comprise at least a lens (2) and a mirror (3a, 3b).

C. The device as set forth in embodiment A, wherein the diverting means (2, 3a, 3b, 9a-9d, 10, 11) comprise a number of mirrors (9a-9d).

D. The device as set forth in embodiment A, wherein the diverting means (2, 3a, 3b, 9a-9d, 10, 11) comprise a number of mirrors (3a, 3b, 11) and a prism (10).

E. The device as set forth in any one of embodiments A to D, wherein the diverting means (2, 3a, 3b, 9a-9d, 10, 11) are arranged on an arch (6).

F. The device as set forth in embodiment E, wherein the laser emitter device (1) and the arch (6) are formed as one piece.

G. The device as set forth in any one of the preceding embodiments, wherein a lens (2) lengthens the shortest beam path length.

H. The device as set forth in any one of the preceding embodiments, wherein the laser emitter (1) simultaneously generates a number of laser beams (4a, 4b, 4c) having different exit angles.

I. The device as set forth in any one of the preceding embodiments, wherein the laser emitter (1) generates laser beams (4a, 4b, 4c) having definable exit angles, in a definable sequence.

J. A device for inscribing an object (5), consisting of:

a) a laser emitter (1) emitting a laser beam (4c);

b) an arrangement of diverting means (2, 3a, 3b, 9a-9d, 10, 11) for directing the laser beams (4a, 4b, 4c) from the exit point of the laser emitter (1) to a focal point on the object (5); wherein a number of sides of the object (5) may be inscribed by movably arranging the diverting means (2, 3a, 3b, 9a-9d, 10, 11).

In the foregoing description, preferred embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. A device for inscribing an object using a laser beam, comprising:
a) a laser emitter for emitting a laser beam; and
b) at least one mapping means for mapping the laser beam from the laser emitter onto a focal point on the object, wherein the laser emitter is designed to emit a laser beam at at least two different exit angles, wherein depending on the exit angle of a laser beam from the laser emitter, at least one laser beam is assigned to a diverting means, such that at least two different sides of the object can be inscribed without changing the position of the object.

2. The device as set forth in claim 1, wherein the laser emitter comprises a laser and at least one deflecting means for changing the exit angle of the laser beam from the laser emitter in each case, by deflecting a laser beam exiting the laser.

3. The device as set forth in claim 2, wherein the deflecting means is a galvano-mirror.

4. The device as set forth in claim 1, wherein a lens is arranged in a first beam path, for mapping the laser beam onto a first side of the object, and wherein at least one mirror is provided in each of at least one other beam path for diverting the laser beam onto at least one other side of the object.

5. The device as set forth in claim 4, wherein a compensating means is provided in the first beam path or in at least one other beam path, to compensate for the difference in optical path length between the first beam path and the at least one other beam path.

6. The device as set forth in claim 5, wherein the compensating means comprises a number of mirrors and a reflector arrangement.

7. The device as set forth in claim 6, wherein the distance between the mirrors and the reflector arrangement of the compensating means can be varied.

8. The device as set forth in claim 4, wherein the diverting means and the compensating means are arranged on a common support, in particular an arch.

9. The device as set forth in claim 8, wherein the laser emitter and the support, in particular the arch, are formed as one piece.

10. The device as set forth in claim 1, wherein the laser emitter generates laser beams in a definable sequence, said beams exiting the laser emitter at definable exit angles.

11. The device as set forth in claim 1, wherein the laser emitter simultaneously generates a number of laser beams which exit the laser emitter at different exit angles.

12. A device for inscribing an object, consisting of:
a) a laser emitter emitting a laser beam;
b) an arrangement of movable diverting means for directing the laser beams from the exit point of the laser emitter to a focal point on the object; wherein a number of sides of the object may be inscribed by moving the diverting means.

13. A device for inscribing a workpiece on a number of sides without changing the position of the workpiece, comprising:
a laser;
a lens; and
at least one mirror, wherein the laser emits at least two laser beams, at least one of which is adjusted and diverted by at least one of the lens and at least one mirror, whereby the at least two beams are substantially similar.

14. The device according to claim 13, wherein at least one of the at least two beams is lengthened by the lens.

15. The device according to claim 13, wherein the laser emits three beams of substantially equal intensity, and wherein the three beams are selectively adjusted and diverted by at least one of the lens and the at least one mirror in order to be able to hit the number of sides of the workpiece.

16. The device according to claim 15, wherein the beams have a path having a length, two of the beams being reflected by the mirrors, and the path of the other one of the beams lengthened using the lens such that the paths of the three beams are substantially identical.
